(19) United States
(12) Patent Application Publication
(10) Pub. No.: US 2017/0213232 A1
(43) Pub. Date: Jul. 27, 2017

(54) Permission Marketing

(71) Applicant: Arthur Wayne Johnson, Macon, GA (US)

(72) Inventor: Arthur Wayne Johnson, Macon, GA (US)

(21) Appl. No.: 14/627,363

(22) Filed: Feb. 20, 2015

(51) Int. Cl. G06Q 30/02; G06F 17/30; G06Q 20/40

(52) U.S. Cl. CPC G06Q 30/0226; G06Q 20/40; G06Q 30/0238; G06F 17/30592

(57) ABSTRACT

The Permission Marketing invention involves the distribution of merchant coupons, discounts, enticements, rewards, and up-front incentives sent via a mobile communication channel, post purchase to a consumer's mobile device. Enrollment is automatic once the consumer registers at least one credit or debit card using a card control application. Rewards are incentives earned by a consumer for using his account on a regular basis and/or in a particular way. The reward frequency and value offered provided by a merchant is dependent on the frequency, amount, and products purchased by a consumer. Merchants desire to increase earnings by encouraging consumers to make purchases with their company rather than a competitor. This invention outlines an improved and effective system and method for encouraging the use of a reward system as a catalyst for consumer merchant selection.

### BACKGROUND

The present invention pertains generally to the distribution of merchant coupons, discounts, enticements, rewards, or up-front incentives sent via a mobile communication channel to a consumer's mobile device post-purchase.

The following definitions may include but are not limited to the following: 1). Coupons are vouchers entitling the holder to a discount for a particular product. 2). Discounts are reduced prices and rebates on products or services purchased by using a specific account at a specific merchant or on a specific product. 3). Enticements are rewards communication used by a merchant to attract a consumer from a competing merchant. 4). Rewards are incentives earned by a consumer for using his account on a regular basis and/or in a particular way. 5). Up-front incentives are specific rewards that may be chosen by a consumer in advance of anticipated purchase of products or services, such as shopping at a specific locations or making a series of purchases with a particular merchant.

Coupons, enticements, discounts, up-front incentives, or rewards, may also include but are not limited to, advertisements, notifications of promotions, regularly occurring deals (i.e. daily, monthly, etc . . . ) or any form of communication from a merchant. These merchant coupons, enticements, discounts, up-front incentives, and rewards are referred to generically herein as “rewards”.

Enrollment to receive rewards is automatic once the consumer registers at least one credit or debit card using a card-control application. Rewards are relevant to the merchant, merchant category, and items/services purchased.

The more that a consumer charges with each merchant, the greater the reward provided. The reward may be provided by the merchant itself or provided in association with a particular merchant or group of merchants with which the merchant has established a joint marketing relationship. It is also possible a competing merchant will provide a reward or enticement. Thus, the reward may be coupons or enticements that can be used for discounts at a particular merchant or group of merchants, such as frequent shoppers at Merchant “X” receiving messages and rewards from competing Merchant “Y” thus increasing competition. Additionally, purchases at a particular merchant or merchants involved in such a partnering relationship may result in more valuable rewards, or the more rapid accumulation of rewards toward achieving a reward threshold level.

### BRIEF SUMMARY OF THE INVENTION

This invention is a process that is launched once the consumer registers at least one credit or debit card using a card-control application and places at least one transaction. The transaction then passes through a card-control feature making available the dollar value of the purchase, the merchant name, and merchant category code (MCC) through the ISO8583 stream. The collected information is then data warehoused and sorted. Logic and rules are applied to the warehoused information and that triggers the selection of promotional messages and rewards sent to the cardholder post-transaction.

Merchants desire to increase earnings both by encouraging potential consumers to make purchases with their company, rather than with a competing merchant, and, after an account has been registered, by encouraging the consumer to engage in particular purchasing activities that may produce increased spending, and/or other revenue for the merchant. For example, as an incentive to make a purchase with a merchant, and keep a consumer's loyalty, a merchant may reduce prices, and/or increase coupons or enticements, as the amount spent by a consumer with the merchant increases. In this case, the revenue lost by the merchant due to reduced prices or discounts is more than offset by earnings gained by the merchant from use of couponing and enticements encouraging the consumer to purchase more items more often.

A great disadvantage of most current schemes for encouraging consumers to shop or frequent particular merchants is that there often is a disconnect and delay between the merchant's providing of the benefit or reward and the consumer's receipt and use of the reward. For example, a consumer who is rewarded with a cash back bonus, discounts, etc., for shopping with a merchant does not receive the benefit of the reward until well after he has shopped with the merchant many times. This disconnect between the rewards provided to encourage consumers to shop particular merchants and to use their rewards in particular ways and the consumer's actual behavior in this regard reduces the effectiveness of the rewards in actually causing the consumer to alter his behavior in the way desired.

What is desired, therefore, is an improved and effective process and method for encouraging the use of a reward system as a catalyst for consumer merchant selection. Also, for rewarding the consumer by engaging in particular purchasing activities in a manner that is likely to cause the consumer to alter their shopping behavior; thus, strengthening the relationship or increasing merchant awareness through competition. Such a system and method preferably is implemented for substantially automatic operation in a computer-based system.

### BRIEF DESCRIPTION OF THE DRAWINGS

FIG. 1 shows the Permission Marketing Process Flow.

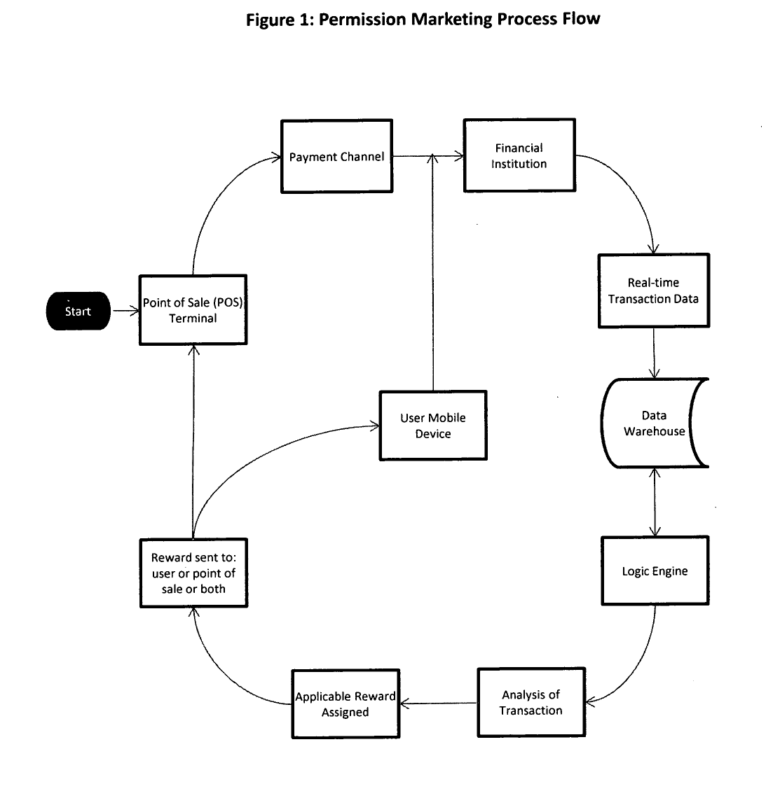

### DETAILED DESCRIPTION AND BEST MODE OF IMPLEMENTATION

The present invention provides a process and method for rewarding consumers for engaging in certain activities associated with particular merchants. In accordance with the present invention, rewards are provided and managed in such a way as to encourage effective and specific types of purchasing and frequency. The intention is to increase revenue for the merchant or offer an opportunity for a competing merchant's products or services to be presented.

A permission marketing incentives rewards management system and method in accordance with the present invention may feature a variety of types of incentives, each of which effectively transfer value from a merchant to a consumer to encourage or reward specific customer behavior with respect to a specific merchant. A permission marketing incentives rewards management system in accordance with the present invention is implemented as an integrated multi-tiered process for managing, in an automated manner, a variety of incentive elements that may be provided to a consumer to encourage specific behavior. Preferably, each element of the process or type of incentive offered may be turned on or turned off by product, merchant, or on an individual consumer basis by the user of a system in accordance with the present invention.

In accordance with the present invention, different incentive types preferably all may be administered through a permission marketing incentives rewards management system, automatically generated by the system from data received on a transactional basis, from various merchant and consumer database systems. In accordance with the present invention, rewards are presented to a consumer and managed in such a way as to maximize the effectiveness of the incentives in encouraging specific behavior by the consumer with respect to his purchasing choices while minimizing the cost of managing such a system by a merchant.

In accordance with the present invention, an enticement may be provided to a consumer before they engage in the purchase of products or services at a similar merchant. This enticement is based on the consumer's prior behavior of engaging in purchasing the same or similar products or services from the same or similar merchants in the future.

In accordance with the present invention, rewards may be provided to consumers as up-front incentives. Up-front incentives are specific rewards that may be chosen by a consumer in advance of anticipated purchase of products or services, such as shopping at a specific locations or making a series of purchases with a particular merchant. If the consumer fails to redeem the up-front reward that was provided to him within a specified period of time, the reward expires and will be removed from the consumer.

In accordance with the present invention, an up-front incentives management system and method also may provide for and manage the provision of discounts to consumers to encourage specific account activity by the consumers. Rewards may include both discounts at the time of purchase of products and/or services and rebates related to purchases already made. Rewards may also include pre-negotiated discounts for consumers who use specific merchants to purchase specific merchandise and/or utilize a specific merchant, e.g., within a given time frame. Examples of rewards may include: “25% off next purchase of a Sony TV”, “Buy one dinner get one dinner free”, “30% off all purchases made next week at Home Depot”, etc. Rewards are granted after the consumer has fulfilled specific purchase requirements and are intended as enticements to encourage the consumer to repeat business with said merchant or competing merchants. Examples of rebates may include: “You just purchased a mobile device, come back and get a free accessory”, “You just purchased a new refrigerator, come back and get a free set of cook wear”, “You just purchased your tenth movie, come back and get a free movie”, etc. Rewards typically may be funded by the vendor, merchant, or service provider selling the goods or services to which the discount or rebate applies. An up-front incentives management system and method in accordance with the present invention preferably lists automatically the details of all rewards available to the consumer in each current consumer permission marketing incentives rewards management system registry.

The listing of rewards in the consumer's permission marketing incentives rewards management system registry is subject to the merchant providing merchandise availability and other data to the merchant's processing system in which an up-front incentives program in accordance with the present invention is implemented.

In accordance with the present invention, rewards issued by merchants will have a time and date stamp or expiration date. Once reward is redeemed by the consumer or it has expired, the reward is removed from the consumer's permission marketing incentives rewards management system registry and is no longer valid.

1. A process comprising: a data warehouse which stores information about the user defined rewards settings.

2. The invention of claim 1 further comprises: a logic engine that reads the ISO 8583 authorization messages from the payment instrument transaction.

3. The invention of claim 2 wherein the logic engine analyzes the transaction and applies the applicable reward.

4. The invention of claim 1 further comprises: the use of Amazon Web Services to send reward messages to the user's mobile phone or web enabled device.

5. The invention of claim 1 resides on Amazon Web Services.
